(19) United States
(12) Patent Application Publication
(10) Pub. No.: US 2022/0193857 A1
(43) Pub. Date: Jun. 23, 2022

(54) Device for the Robot-Assisted Machining of Surfaces

(71) Applicant: FerRobotics Compliant Robot Technology GmbH, Linz (AT)

(72) Inventor: Ronald Naderer, Linz (AT)

(21) Appl. No.: 17/604,586

(22) PCT Filed: Apr. 17, 2020
(86) PCT No.: PCT/EP2020/060818

§ 371 Date: Oct. 18, 2021

(30) Foreign Application Priority Data
Apr. 19, 2019 (DE) 10 2019 110 421.1

(51) Int. Cl. B24B 27/027; B25J 11/00; B24B 27/00; B24B 49/08; B24B 41/02

(52) U.S. Cl. CPC B24B 27/027; B25J 11/0065; B24B 41/02; B24B 49/08; B24B 27/0038

(57) ABSTRACT

One exemplary embodiment relates to a device for the robot-assisted machining of surfaces. According to one example, the device has a carrier structure, a motor, a linear actuator, and a machining head. The machining head is coupled to the carrier structure by means of the linear actuator and has a drive shaft for directly or indirectly driving a rotatable tool. The device also has a flexible shaft, which couples a motor shaft of the motor to the drive shaft of the machining head.

### TECHNICAL FIELD

The present disclosure relates to the field of Robotics and, in particular, to an apparatus for the robot-supported machining of workpiece surfaces.

### BACKGROUND

In the robot-supported machining of workpiece surfaces, a machine tool such as, e.g. a grinding or polishing machine (e.g. an electrically driven grinding machine with a rotating grinding disc as grinding tool) is guided by a manipulator, for example, an industrial robot. While doing so, the machine tool can be coupled to the so-called TCP (Tool Center Point) of the manipulator in various ways; the manipulator can generally adjust the position and orientation of the machine as desired and can move the machine tool along a trajectory, e.g. parallel to the surface of the workpiece. Industrial robots are generally position-controlled, which makes a precise movement of the TCP along the desired trajectory possible.

In order to achieve good results during robot-supported grinding, in many applications the processing force (grinding force) must be controlled, which is often difficult to realize with adequate precision using conventional industrial robots. The mass inertia of the large and heavy arm segments of an industrial robot is too high for a controller (closed-loop controller) to be able quickly enough to large fluctuations of the processing force. In order to solve this problem, a linear actuator, which is smaller (and lighter) than the industrial robot, can be arranged between the TCP of the manipulator and the machine tool to couple the TCP of the manipulator to the machine tool. The linear actuator only controls the processing force (that is, the pressing force between the tool and the workpiece) while the surface is being machined, whereas the manipulator moves the machine tool, together with the linear actuator, along the desired trajectory in a position-controlled manner By controlling the force, the linear actuator can compensate (within certain limits) inaccuracies in the position and form of the machined workpiece, as well as inaccuracies in the trajectory of the manipulator. It may nevertheless be problematic for the machining results if the robot does not apply the grinding tool to the surface of the workpiece tangentially.

The inventor identified a need for an improved apparatus for the robot-supported machining of surfaces, as well as a corresponding method wherein, in particular, the requirements regarding the precision with which the robot carries out its movements should be relaxed.

### SUMMARY

Various embodiments of an apparatus for the robot-supported machining of a workpiece surface as well as related methods are described herein.

One embodiment refers to an apparatus for the robot-supported machining of surfaces. In accordance with one example, the apparatus comprises a backing pad for mounting the apparatus onto a manipulator, a motor, a linear actuator and a machining head. The machining head is coupled to the backing pad by means of the linear actuator and comprises a drive shaft for directly or indirectly driving a rotatable tool. The apparatus further comprises a flexible shaft which couples the one motor shaft of the motors to the drive shaft of the machining head. The backing pad need not necessarily be mounted on a manipulator, it may instead be stationary, for example, a part of a housing, of a tripod or of some other suspension.

In a further embodiment, the apparatus further comprises a universal joint that couples the machining head and the linear actuator such so as to enable a biaxial tilting of the machining head.

### SHORT DESCRIPTION OF THE FIGURES

Various embodiments will now be described in the following with reference to the examples illustrated in the figures. The illustrations are not necessarily true to scale and the described embodiments are not limited to the aspects illustrated here. Instead,. importance is given to illustrating the underlying principles. The figures show:

FIG. 1 is an exemplary schematic illustration of a robot-supported grinding apparatus with a grinding machine that is coupled to an industrial robot by means of a force-controlled linear actuator; the linear actuator effects a mechanical decoupling of the industrial robot and the grinding machine.

FIG. 2 illustrates an exemplary embodiment of a machine tool with an integrated liner actuator for the mechanical decoupling of a drive side and a tool side of the machine tool.

FIG. 3 illustrates a part of the apparatus from FIG. 2, wherein the machining head (e.g. a grinding head) is tilted relative to the linear actuator by means of a universal joint.

FIG. 4 contains lateral views of the apparatus from FIG. 3.

FIGS. 5 and 6 illustrate a further example embodiment in which an axis of rotation of a machining head is inclined relative to the axis of rotation of the motor by approximately 90°.

FIGS. 7 and 8 a further exemplary embodiment which has numerous machining heads.

FIG. 9 schematically illustrates a further example in which the apparatus is not mounted on a manipulator.

### DETAILED DESCRIPTION

Before the various embodiments are explained in detail, first a common example of a robot-supported grinding apparatus will be described. It is to be understood that the concepts described here can also be applied in other kinds of surface machine (e.g. polishing) and that they are not limited to grinding applications. In the following, example embodiments will be explained with reference to a grinding machine with a rotating grinding tool (grinding disc). The concepts described here, however, are not limited to this and may also be applied to other machine tools, for example, those having circulating tools (e.g. belt sanders) or having oscillating or vibrating tools (e.g. orbital sanders).

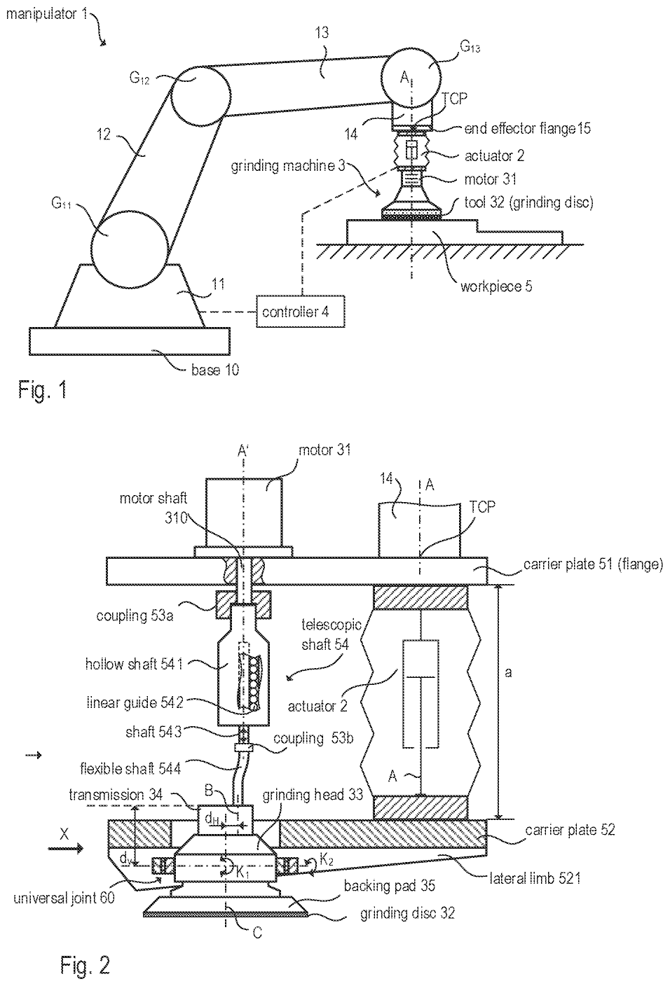

In accordance with FIG. 1, the apparatus comprises a manipulator 1, for example, an industrial robot, and a grinding machine 10 with a rotating grinding tool (e.g. an orbital sander), wherein the latter is coupled to the so-called tool center point (TCP) of the manipulator via a linear actuator 20. Strictly speaking, the TCP is not actually a point, but rather a vector and it can be described, e.g. with three spatial coordinates and three angles. Occasionally generalized coordinates (usually six joint angles of the robot) in configuration space are also used in Robotics to describe the position of the TCP. The position and orientation of the TCP are sometimes referred to as “Pose”. The position (including orientation) of the TCP as a function of time defines the movement of the grinding tool that is referred to as “trajectory”.

In the case of an industrial robot with six degrees of freedom, the manipulator may be comprised of four segments 2a, 2b, 2c and 2d, each of which is connected via the joints 3a, 3b, and 3c. The first segment 11 is generally rigidly attached to a base 10 (which, however, need not necessarily be the case). The joint G₁₁ connects the segments 11 and 12. The joint G₁₁ may be biaxial and allow for a rotation of segment 12 around a horizontal axis of rotation (elevation angle) and around a vertical angle of rotation (Azimuth angle). The joint G₁₂ connects the segments 13 and 12 and allows for a swivel movement of segment 13 relative to the position of segment 12. The joint G₁₃ connects the segments 14 and 13. The joint G₁₃ may be biaxial and thereby (similar to the joint G₁₁) allow for a swivel movement in two directions. The TCP has a permanent relative position in relation to segment 14, wherein the latter generally also includes a rotational joint (not shown) which allows for a rotational movement of the end effector flange 15 that is arranged on segment 14 around a longitudinal axis A of segment 14 (in FIG. 1 designated with a dash-dotted line and corresponding, in the example illustrated here, to the axis of rotation of the grinding tool, as well). Every axis of a joint has a dedicated actuator (e.g. an electric motor) that can effect a rotational movement around the respective joint axis. The actuators in the joints are controlled by a robot controller 4 in accordance with a robot program. Various industrial robots/manipulators and their respective controllers are already well known and will therefore not be discussed here in further detail.

The manipulator 1 is generally position-controlled, i.e. the robot controller can determine the pose (position and orientation) of the TCP and can move it along a previously defined trajectory. In FIG. 1 the longitudinal axis of segment 14 on which the TCP lies is designated A. When the actuator 2 comes to rest against an end stop, the pose of the TCP also defines the pose of the grinding machine 10 (and thus also that of the grinding disc 11). As mentioned earlier, the actuator 2 serves to adjust the contact force (machining force) between the tool and the workpiece 5 to a desired value. In general, controlling the force directly by means of the manipulator 1 is too imprecise for grinding applications, as the high mass inertia of the segments 11 to 14 renders a quick compensation of force surges (e.g. such as occurs when the grinding tool is applied to the workpiece 4) using conventional manipulators virtually impossible. For this reason the robot controller 4 is configured to control the pose (position and orientation) of the TCP of the manipulator 1, whereas the force adjustment is carried out exclusively by the actuator 2.

As mentioned earlier, during the grinding process, the contact force F_{K} between the grinding tool (grinding machine 3 with grinding disc 32) and the workpiece 5 can be adjusted, with the aid of the linear actuator 2 and a force controller (which, for example, can be implemented in the controller 4), such that the contact force F_{K} (in the direction of the longitudinal axis A) between the grinding disc 32 and the workpiece 5 corresponds to a specifiable target value. The contact force F_{K} here is a reaction to the actuator force F_{A} with which the linear actuator 2 presses against the surface of the workpiece. When contact between the workpiece 5 and the tool is absent, because of the absence of contact force on the workpiece 5, the actuator 2 comes to rest against an end stop (not shown here because it is integrated in the actuator 2) and presses against it with a defined force. During this entire process, the force control is active. In this situation (no contact), the actuator deflection is therefore at its maximum and the actuator 2 is in an end position. The defined force with which the actuator 2 presses against the end stop may be very small or (theoretically) may even be adjusted to zero, in order to ensure that the workpiece surface is contacted as gently as possible.

The position controller of the manipulator 1 (which may also be implemented in the controller 4) can operate completely independently of the force controller of the actuator 2. The actuator 2 is not responsible for the position of the grinding machine 3 but only for the adjustment and maintenance of the desired contact force F_{K} during the grinding process and for detecting when contact between the tool 32 and the workpiece 5 takes place. Contact can be detected, for example, in a simple manner, namely by the actuator moving out of its end position (the actuator deflection a becomes smaller than the maximum deflection a_{MAX} at the end stop).

The actuator 2 may be a pneumatic actuator, e.g. a double acting pneumatic cylinder. Other kinds of pneumatic actuators, however, may also be used such as, e.g. a bellows cylinder or an air muscle. As an alternative, direct electric drives (gearless) may also be considered. It should be understood that the effective direction of the actuator 2 and the axis of rotation of the grinding machine 3 need not necessarily coincide with the longitudinal axis A of segment 14 of the manipulator 1. When a pneumatic actuator is used, the force adjustment can be realized in a conventionally known manner with the aid of a control valve, a regulator (e.g. implemented in the controller 4) and a compressed air tank or compressor. Since the perpendicular slope is relevant when the gravitational force is taken into account (i.e. the weight force of the grinding machine 3), the actuator 2 can contain an inclination sensor or it can determine this information based on the joint angles of the manipulator 1. The determined inclination is taken into account by the force regulator. The specific implementation of the force adjustment is generally known and, as it is of little importance for the remaining discussion, it will not be described here in further detail.

The grinding machine 3 usually has an electric motor that drives the grinding disc 32. In the case of an orbital sander—as well as in the case of other grinding machines—the grinding disc 32 is mounted on a backing pad which, in turn, is connected to the motor shaft of the electric motor. Asynchronous or synchronous motors may be considered for the electric motor. Synchronous motors have the advantage that the rotational speed does not change together with the load (but only the slip angle), whereas in asynchronous machines the rotational speed is reduced as the load grows. The load on the motor is here essentially proportional to the contact force F_{K} and the friction between the grinding disc 32 and the machined surface of the workpiece 5.

As an alternative to grinding machines with electric drive, grinding machines with pneumatic motors (compressed air motor) may also be used. Grinding machines that operate with compressed air can be relatively compactly constructed as compressed air motors generally have a small power to weight ratio. Regulating the rotational speed with the aid, for example, of a pressure control valve (e.g. electrically driven by the controller 4) is easy to realize (additionally or alternatively also using a throttle), whereas, when a synchronous or asynchronous motor is used, a frequency converter (e.g. electrically driven by the controller 4) is needed to adjust the rotational speed. The concepts described here can be implemented with a large number of different kinds of grinding machines, polishing machines and others commonly used in the machining of workpiece surfaces.

In particular in grinding machines that contain an electric motor, the electric motor may make up a considerable part of the machine's weight. In the following examples, the actuator 2 is not only used to mechanically decouple the manipulator 1 from the workpiece, but also serves to mechanically decouple the motor of the grinding machine from the machining head on which the grinding disc is mounted. The machining head of a grinding machine is referred to as a “sanding head”. Furthermore, some of the following embodiments allow for the compensation (within certain limits) of an inexact positioning of the grinding machine relative to the surface of the workpiece, which may reduce the time and effort needed to create the robot program.

In accordance with the example illustrated in FIG. 2, the machine tool 3 comprises a first carrier plate 51 and a second carrier plate 52. The first carrier plate 51 is implemented such that it can be mounted onto a manipulator 1, for example, on the end effector flange 15 of the manipulator 1 from FIG. 1. A sanding head 33, which will be described in greater detail further on, is mounted on the second backing pad 52. When in operation, a grinding disc 32 can be mounted onto a rotatable backing pad 35 of the sanding head 33. A linear actuator 2 is arranged between the two carrier plates 51 and 52. The linear actuator 2 operates between the two carrier plates 51 and 52 such that the distance a between the two carrier plates 51, and 52 depends on the deflection of the linear actuator 2. As described above, when in operation the linear actuator 2 is driven in a force-controlled manner such that the actuator force takes effect between the two carrier plates 51 and 52. When the tool 32 is not in contact with a surface, the linear actuator 2 presses against an end stop of the actuator 2 (not illustrated) with a target actuator force. The actuator 2 may be a pneumatic linear actuator and may contain, for example, a double acting pneumatic cylinder. Other kinds of actuators, however, may also be employed. Here it should be noted that the carrier plates 51 and 52 need not necessarily be flat plates, but instead may comprise any supporting structure or may be part of such a supporting structure. Neither do the carrier plates 51 and 52 need to be constructed of one piece but instead may be assembled from numerous pieces.

The grinding/sanding head 33 can basically be regarded as a grinding machine without a drive (motor). The sanding head 33 comprises a drive shaft (with the axis of rotation C) which directly or indirectly drives the backing pad 35 on which the grinding disc 32 is arranged. The sanding head 33 may also contain a transmission that effects an eccentric rotation of the backing pad 35, as is commonly the case with orbital sanders. One example of a sanding head is shown in the publication EP 0237854 A2 (corresponding to U.S. Pat. No. 4,759,152) and will therefore not be discussed here further.

A motor 31 (e.g. an electric motor) for driving the backing pad 35 of the sanding head 33 is mounted on the first carrier plate 51 in accordance with the embodiments described here. In accordance with the example from FIG. 2, the motor 31 is mounted on the first carrier plate 51, whereby the motor shaft 310 extends through the first backing pad 51. The distance between the two carrier plates 51 and 52 is “bridged” by a flexible shaft 544 and the telescopic shaft 54, whereas the telescopic shaft 54 is optional. This means that the motor shaft 310 is coupled to the drive shaft (axis of rotation C) of the sanding head 33 via the flexible shaft 544, which it drives. In order to avoid an excessive bending of the flexible shaft 544, one end of the motor shaft 310 may be coupled to the telescopic shaft 54 (shaft coupling 53a) and the other end of the telescopic shaft 54 may be coupled to the flexible shaft 544 (shaft coupling 53b). The flexible shaft 544 drives the drive shaft (axis of rotation C) of the sanding head 33 either directly or—as shown in FIG. 2—via a transmission 34. The drive shaft of the transmission 34 has an axis of rotation that is designated B in FIG. 2. The flexible shaft 544 is bendable (i.e. the longitudinal axis of the shaft is bent with a variable bending) and differs from conventional joint shafts that comprise two or more rigid shaft segments connected via a (universal) joint.

The telescopic shaft 54 comprises two shaft parts (a hollow shaft/sheath 541 and a sliding shaft segment 543) which can be moved relative to each other. A first part of the two shaft parts is coupled to the motor shaft 33 of the motor 31 (for example, by means of the shaft coupling 53a) and a second part of the two shaft parts is connected to the flexible shaft 544 (for example, by means of the shaft coupling 53b).

The second shaft part 543 of the telescopic shaft 54 can be slid relative to the first shaft part (hollow shaft 541) along the axis of rotation of the telescope shaft 54. For this purpose, the hollow shaft 541 (first shaft part) may include a linear guide 542 which allows for a displacement of the second shaft part 543 along the axis of rotation of the telescopic shaft 54. As previously mentioned, the telescopic shaft 54 is optional. Without the telescopic shaft, however, it may be that, in some applications, the flexible shaft 544 may be exposed to more bending stress than in those cases in which a telescopic shaft 54 is additionally employed.

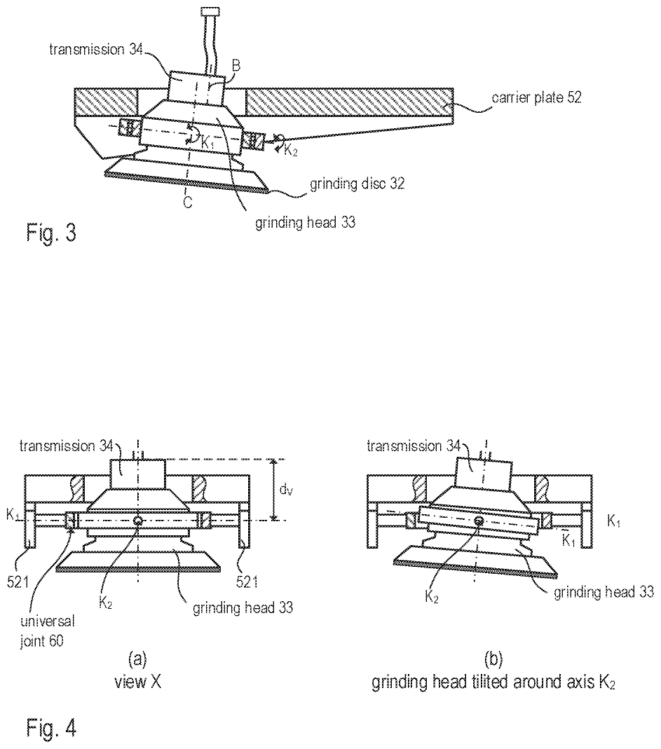

In the example from FIG. 2 the sanding head 33 is mounted on the backing pad 52 by means of a universal joint 60 in order to allow for a biaxial tilting movement of the sanding head 33 (relative to the backing pad 52). The biaxial tilting movement is made possible by tilting around a first tilt axis K₁ and around a second tilt axis K₂. FIG. 3 shows the lower part of the apparatus from FIG. 2 (the backing pad 52 with the universal joint 60 and the sanding head 33), wherein the sanding head 33 is tilted around the tilt axis K₁. FIG. 4 shows a lateral view X of the lower part of the apparatus from FIG. 2, wherein in diagram (a) of FIG. 4 the sanding head 33 is in its normal position and in diagram (b) of FIG. 4 the sanding head 33 is tilted around the tilt axis K₂. The universal joint can be mounted on two lateral limbs 521 and 522 of the backing pad 52. Employing a universal joint as a means of cardanic suspension is commonly known and will therefore not be discussed here in further detail.

Here it should be noted that, when the sanding head 33 is tilted, the axes of rotation B and C are also tilted (see FIG. 2). This tilting of the axes of rotation B and C, however, can be compensated for with a corresponding bending of the flexible shaft 544. It should further be pointed out that the tilt axes K1 and K2 of the universal joint 60 lie (in the normal, non-tilted state) on one plane which is below the plane on which the lower end of the flexible shaft is located. The vertical distance between the tilt axes K1 and K2 and the lower end of the flexible shaft 544 is designated d_{V} in FIG. 2. Furthermore, the lower end of the flexible shaft 544 is disposed coaxially to the axis of rotation B, which is spaced apart in horizontal direction from the axis of rotation C of the grinding tool (horizontal distance d_{H}). In general it is desirable to arrange the universal joint 60 at as small of a distance as possible to the grinding disc 32 so that the tilt axes K₁ and K₂ are located as far below as possible.

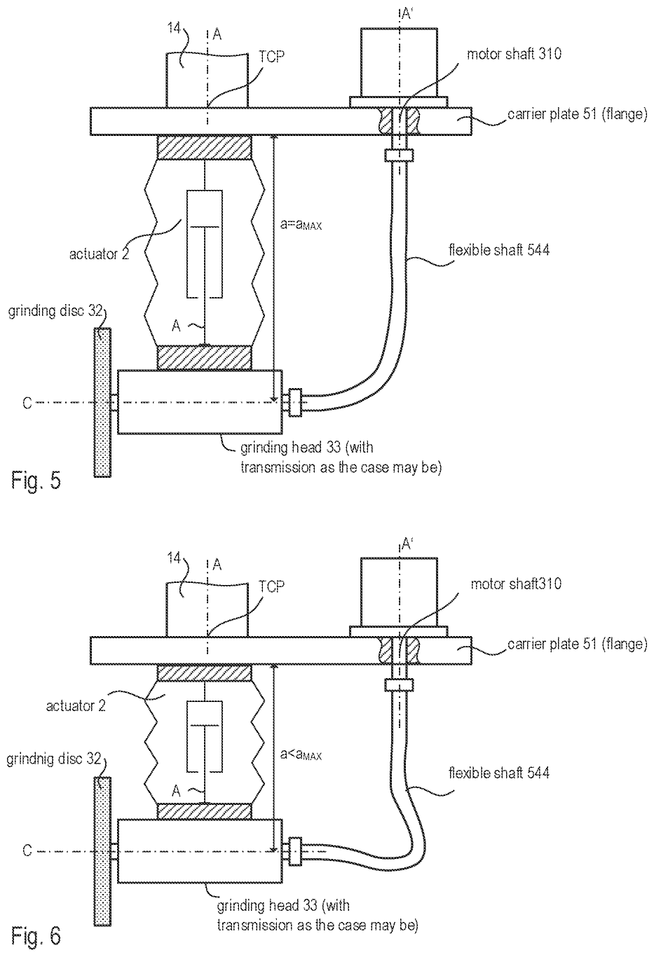

The embodiment illustrated in FIGS. 5 and 6 shows a grinding apparatus in which the grinding disc 32 rotates around an axis of rotation C that is not coaxial to the motor shaft 310 (axis of rotation A′). In the illustrated example, the axis of rotation A′ of the motor shaft 310 stands at a right angle on the horizontal plane on which the axis of rotation C of the grinding disc 32 lies. The flexible shaft 544 that connects the motor shaft 310 and the drive shaft (axis of rotation C) of the sanding head 33 is bent at approximately 90° in this case. In order to reduce the maximum bending of the flexible shaft 544, a telescopic shaft may also be arranged in this case between the motor shaft 310 and the flexible shaft 544 (cf. FIG. 2).

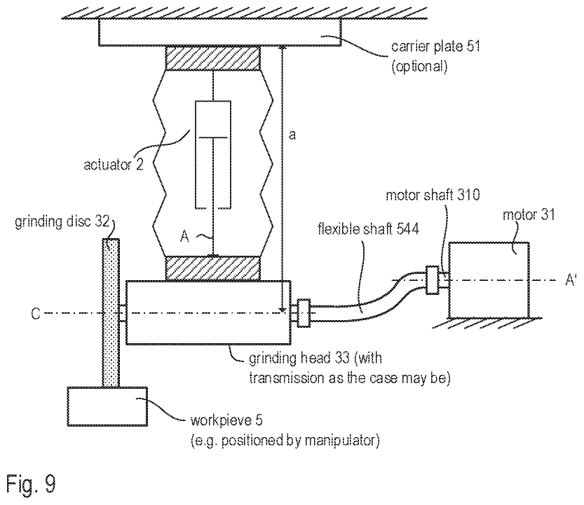

The actuator 2 couples the sanding head 33 to the upper carrier plate 51. The distance a between the axis of rotation C of the grinding disc 32 and the carrier plate 51 depends on the deflection of the actuator 2. The lower carrier plate 52 (cf. FIG. 2) is not needed in this example (depending on the design of the sanding head 53). FIG. 5 shows the apparatus with the maximum deflection of the actuator 2 (distance a=a_{MAX}), wherein the deflection of the actuator is limited by its end stop in this situation. FIG. 6 shows the apparatus with a smaller deflection of the actuator 2 (a<a_{MAX}) which is the case, for example, when the grinding disc 32 touches a surface. Here it should be noted that the carrier plate 51 need not necessarily be mounted on a manipulator but may also have a stationary mounting. In such a case the workpiece can be positioned, e.g. by means of a manipulator, relative to the machining tool 32. In this connection reference is also made to the example from FIG. 9.

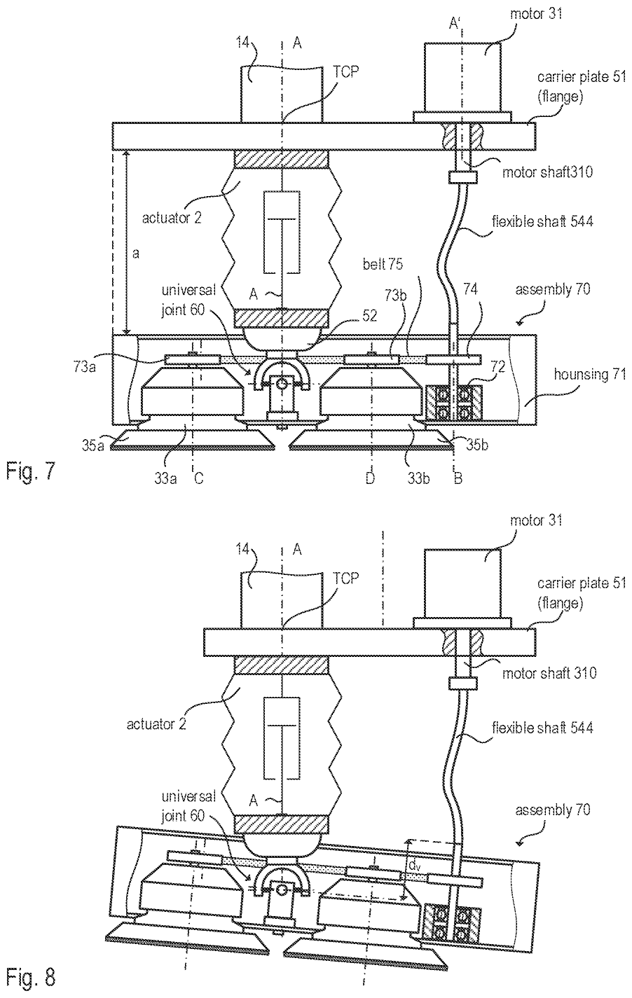

FIGS. 7 and 8 show a further embodiment with numerous sanding heads 33a, 33b which, similar to the example from FIG. 2, can be tilted around two axes. The upper part of the apparatus illustrated in FIG. 7 (carrier plate 51, motor 31, actuator 2), is the same as that of the example from FIGS. 2 and 6 and reference is made to the corresponding explanations above. Instead of a single sanding head 33, however, the apparatus from FIG. 7 comprises an assembly 70 with two or more sanding heads 33a, 33b. The entire assembly 70 is coupled to the actuator 2 by means of a universal joint 60. In the example illustrated in FIG. 7 one end of the universal joint 60 is mounted on a carrier plate 52, which itself is rigidly attached to the lower end of the actuator 2. The other end of the universal joint 60 is mounted on a housing 71 of the assembly 70. In this example as well the intersection of the tilt axis of the universal joint 60 lies at a vertical distance dV below the lower end of the flexible shaft 544 and in this example it is also desirable for the universal joint 60 to be arranged as far below as possible. As it is possible, as opposed to the example from FIG. 2, when numerous sanding heads are employed, to arrange the universal joint 60 between the sanding heads, the joint can be more simply implemented and no cardanic suspension is needed as in FIG. 2.

Numerous sanding heads 33a, 33b are arranged in the housing 71 such that the rotatable backing pads 35a and 35b protrude at the bottom out of the housing. In the present example, the axes of rotation of the drive shafts of the sanding heads 33a and 33b are respectively designated C and D. A pulley 73a is mounted on the drive shaft of the sanding head 33a and another pulley 73b is mounted on the drive shaft of the sanding head 33b. In one particular embodiment (not shown in FIGS. 7 and 8), a third sanding head 33c with a pulley 73c is provided, wherein the axes of rotation of the three sanding heads are each arranged offset at 120° to the longitudinal axis A of the actuator 2. Here it should be pointed out that, instead of a belt drive, any other kind of transmission (e.g. a gear transmission) can also be employed. The transmission, just as the belt drive in the examples described here, serves the purpose of transmitting the mechanical power. How this transmission of the mechanical power is specifically implemented is of no particular relevance.

A further shaft (axis of rotation B) is mounted in the housing 71 of the assembly 70 (see FIG. 7, bearing 72) and is connected to the motor shaft 310 via the flexible shaft 544. A further pulley 74 is mounted on the shaft with the axis of rotation B and a belt 75 connects the pulley 74 (driven by the motor 31 via the flexible shaft 544) to the pulleys 73a, 73b (and, if included, 73c), allowing the drive shafts of all sanding heads 33a, 33b (and, if included, 33c) to be driven by the belt. The vertical distance a between the assembly 70 (in its non-tilted, normal position, as shown in FIG. 7) and the upper carrier plate 51 depends on the deflection of the actuator 2. Both a change in the distance a, as well as a tilting of the assembly 70, can be compensated for by means of the flexible shaft 544. FIG. 8 shows the apparatus from FIG. 7 with a tilted assembly 70.

FIG. 9 illustrates a further embodiment in which the apparatus is not mounted on a manipulator but rather is stationarily mounted. In this case the workpiece can be positioned relative to the grinding disc with the aid of a manipulator. In accordance with FIG. 9, the carrier plate 51 is stationarily mounted. The carrier plate 51 can be regarded as a part of any supporting structure (this applies to all of the embodiments) or it may be mounted on any supporting structure. As the supporting structure, a housing, a tripod or similar, for example, may be considered. The carrier plate 51 may also be regarded a part of the actuator 2 (this also applies to all of the other embodiments). Similarly to the example from FIG. 5, the actuator 2 directly or indirectly couples the carrier plate 51 to a machining head 33 (grinding head) which, in the simplest of cases, may contain a rotatably mounted shaft on which the machining tool such as, e.g. the grinding disc 32, is mounted. During the machining process the workpiece 5 is positioned (e.g. with the aid of a manipulator) and the actuator 2, as described above, takes over the regulation of the contact force. Or, if no contact with the workpiece takes place, the actuator 2 presses with a defined force (adjusted by means of the force controller) against an end stop.

In the example from FIG. 9 the motor 31 is also stationarily mounted (e.g. on the same supporting structure as the actuator 2) and thereby has a variable relative position to that of the grinding head 33, which can be compensated for by means of a flexible shaft 544 (in the same manner as in the other embodiments). Here it should be pointed out that, also the previously described embodiments, in which the (at least one) grinding head is tiltably mounted on the actuator by means of a cardanic suspension or a universal joint, can be stationarily operated while the workpiece is positioned with the aid of a manipulator.

In the following a few aspects of the embodiments described here will be summarized, whereby this will be merely an exemplary, but by no means an exhaustive listing of the relevant technical features. The embodiments refer to an apparatus for the robot-supported machining of surfaces. In accordance with a general embodiment, the apparatus comprises a carrier plate for mounting the apparatus onto a manipulator (see, e.g. FIGS. 2, 5 and 7, carrier plate 51), a motor, a linear actuator and (at least) one machining head (see, e.g. FIGS. 2, 5, grinding head 33 or FIG. 7, grinding heads 33a, 33b). The machining head is (directly or indirectly) coupled to the carrier plate by means of the linear actuator and comprises a drive shaft (see, e.g. FIG. 2, axis of rotation B, FIGS. 5 and 7, axis of rotation C) to directly or indirectly drive the rotating tool. The apparatus further comprises a flexible shaft which, directly or indirectly (e.g. via an additional telescopic shaft), couples a motor shaft of the motor to the drive shaft of the machining head.

As previously mentioned, the carrier plate need not necessarily be mounted on a manipulator. Alternatively, the machined workpiece may also be positioned by a manipulator; in the case the carrier plate is stationary, for example, as part of a housing, of a tripod or of another supporting structure. The motor may be mounted on the same carrier plate as the actuator. This, however, is not necessary due to the flexible shaft. As already mentioned, carrier plate are not necessarily plane pads, but may instead include any supporting structure.

In some embodiments a universal joint is used to mechanically couple the (at least one) machining head to the linear actuator. This allows for a biaxial tilting of the machining head. In this example from FIGS. 2-4, the universal joint is realized by means of a cardanic suspension, whereas in the example from FIGS. 7 and 8, a simple universal joint (cardanic joint) is used. Depending on the application, the universal joint may be replaced by a uniaxial joint, in which case a tilting in only one direction around an axis of tilt will be possible.

In accordance with the embodiments described here, the apparatus comprises a support structure which is arranged on one end of the linear actuator, whereas the other end of the linear actuator is mounted on the carrier plate. The universal joint may be used to form, as mentioned, a cardanic suspension, by means of which the machining head is mounted on the support structure. In the simplest of cases, the supporting structure may be a further carrier plate (see, e.g. FIGS. 2-4, base plate 52 with lateral limbs 521 and 522). The support structure may have an opening through which the machining head or the flexible shaft extends (see FIG. 3, the grinding disc 32 is below the carrier plate 52 and the flexible shaft is coupled to the grinding head 33 above the carrier plate 52). The two axes of tilt of the universal joint are arranged at a distance to the topside of the machining head (see FIG. 2, distance d_{V}) and extend through the machining head. This makes it possible for the axes of tilt to be arranged relatively close to the workpiece, thereby preventing a catching of an edge of the grinding head during the grinding process. In the example from FIG. 2, the two axes of tilt intersect each other and an axis of rotation of the grinding head at one point. The machining head may comprise a transmission (see FIG. 3, transmission 34), allowing an axis of rotation of the rotating tool and an axis of rotation of the drive shaft to be arranged axially offset from each other (see FIG. 2, distance d_{H}).

In accordance with some of the embodiments, numerous machining heads are mounted on the support structure and the support structure is coupled to a linear actuator by means of a universal joint. This is the case, e.g. in the example from FIG. 7, in which the support structure is formed by a housing 71 of an assembly 70. The universal joint makes a tilting around two axes of tilt possible which, in accordance with a particular embodiment, may intersect each other at a certain point of intersection, through which the longitudinal axis of the actuator also extends. The universal joint is arranged inside of the housing of the assembly and the grinding heads are arranged around the universal joint. For example, each of three grinding heads may be arranged offset at 120° (in relation to the longitudinal axis of the actuator and of the joint) around the universal joint. The axes of tilt of the universal joint lie on one plane, through which the grinding heads extend and which thereby lies as close as possible to the surface of the workpiece.

A shaft is mounted by means of a bearing on the support structure (e.g. the housing 71, see FIG. 7), which is connected to a flexible shaft and can thus be driven by the motor. This shaft is connected to the drive shafts of the grinding heads by means of a transmission, for example, a belt transmission.

In very general terms, the flexible shaft makes it possible to couple the motor to the grinding heads even when the relative position of the grinding heads in relation to the motor is variable. Changes in the relative position can be compensated for by means of the flexible shaft. The axes of rotation of the motor shaft and grinding head need not be parallel to each other and may even form an angle of almost 90° (see FIG. 5). In order to avoid an over-bending of the flexible shaft, the latter may be combined with a telescopic shaft (see FIG. 2).

Terms such as “first”, “second”, and the like, are used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

It is to be understood that the features of the various embodiments described herein may be combined with each other, unless specifically noted otherwise.

Although various embodiments have been illustrated and described with respect to one or more specific implementations, alterations and/or modifications may be made to the illustrated examples without departing from the spirit and scope of the appended claims. With particular regard to the various functions performed by the above described components or structures (units, assemblies, devices, circuits, systems, etc.), the terms (including a reference to a “means”) used to describe such components are intended to correspond—unless otherwise indicated—to any component or structure that performs the specified function of the described component (e.g., that is functionally equivalent), even if it is not structurally equivalent to the disclosed structure that performs the function in the herein illustrated exemplary implementations of the invention.

It will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1-17. (canceled)

18. An apparatus comprising:
a carrier plate;
a motor;
a linear actuator;
a machining head coupled to the carrier plate by the linear actuator, the machining head comprising a drive shaft for direct or indirect driving of a rotatable tool; and
a flexible shaft which couples a motor shaft of the motor to the drive shaft of the machining head.

19. The apparatus of claim 18, further comprising:
a universal joint which couples the machining head to the linear actuator such that a biaxial tilting of the machining head is made possible.

20. The apparatus of claim 19, further comprising:
a support structure which is connected to a first end of the linear actuator,
wherein a second end of the linear actuator is connected to the carrier plate,
wherein the universal joint forms a cardanic suspension for mounting the machining head on the support structure.

21. The apparatus of claim 20, wherein the universal joint enables a tilting movement around two axes of tilt which extend from a topside of the machining head through the machining head at a distance to each other.

22. The apparatus of claim 20, wherein the support structure comprises a carrier plate with two diametrically opposed limbs, and wherein the machining head is mounted on the two limbs by the cardanic suspension.

23. The apparatus of claim 22, wherein the support structure comprises an opening through which the machining head or the flexible shaft extends.

24. The apparatus of claim 19, further comprising:
a support structure that is connected to a first end of the linear actuator by the universal joint,
wherein a second end of the linear actuator is connected to the carrier plate, and
wherein one or more machining heads are mounted on the support structure.

25. The apparatus of claim 24, wherein the universal joint allows for a tilting movement around two axes of tilt, and wherein the two axes of tilt intersect at an intersection point through which a longitudinal axis of the actuator also extends.

26. The apparatus of claim 25, wherein the two axes of tilt lie on one plane through which the machining heads extend.

27. The apparatus of claim 24, wherein two or more machining heads are mounted on the support structure, and wherein the two or more machining heads are arranged around the universal joint.

28. The apparatus of claim 24, wherein, via a bearing, a shaft is mounted on the support structure which is connected to the flexible shaft and which drives each drive shaft of the two or more machining heads by a transmission.

29. The apparatus of claim 28, wherein the transmission is a belt transmission or a gear transmission.

30. The apparatus of claim 18, wherein the machining head comprises a transmission such that an axis of rotation of the rotatable tool and an axis of rotation of the drive shaft are axially offset to each other.

31. The apparatus of claim 18, wherein an axis of rotation of the rotatable tool and an axis of rotation of the motor shaft extend approximately at a right angle to each other.

32. The apparatus of claim 18, wherein the motor shaft of the motor and the drive shaft of the machining head are coupled to each other by a flexible shaft and a telescopic shaft.

33. An apparatus comprising:
a carrier plate;
a motor;
a linear actuator;
a machining head which is coupled to the carrier plate by the linear actuator, the machining head comprising a drive shaft for direct or indirect driving of a rotatable tool;
a flexible shaft which couples a motor shaft of the motor to the drive shaft of the machining head;
a universal joint which mechanically couples the machining head to the linear actuator to enable a tilting movement of the machining head around two axes of tilt, which intersect at an intersection point through which a longitudinal axis of the actuator also extends; and
a support structure which is connected to a first end of the linear actuator by the universal joint,
wherein a second end of the linear actuator is connected to the carrier plate,
wherein the machining head or a plurality of machining heads are mounted on the support structure.

34. An apparatus comprising:
a carrier plate;
a motor;
a linear actuator;
a machining head which is coupled to the carrier plate by the linear actuator, the machining head comprising a drive shaft for direct or indirect driving of a rotatable tool;
a flexible shaft which couples a motor shaft of the motor to the drive shaft of the machining head;
a universal joint which mechanically couples the machining head to the linear actuator to enable a tilting movement of the machining head around two axes of tilt,
wherein the universal joint allows for a tilting movement around the two axes of tilt which extend at a distance to each other from a topside of the machining head through the machining head.
